(19) United States
(12) Patent Application Publication
(10) Pub. No.: US 2022/0117232 A1
(43) Pub. Date: Apr. 21, 2022

(54) ANTIMICROBIAL COMPOSITION

(71) Applicant: BASF SE, Ludwigshafen am Rhein (DE)

(72) Inventors: Dennis Frederick Berry, Wyandott, MI (US); Kenneth L. Zack, Wyandott, MI (US); Abhijit Natu, Florham Park, NJ (US)

(21) Appl. No.: 17/268,751

(22) PCT Filed: Aug. 16, 2019
(86) PCT No.: PCT/US2019/046784

§ 371 Date: Feb. 16, 2021

Related U.S. Application Data
(60) Provisional application No. 62/765,309, filed on Aug. 20, 2018.

(51) Int. Cl. A01N 59/16; A01N 25/10; A01N 43/40; A01N 37/16; A01P 1/00; A23L 3/3544; A23L 3/3517; A23B 4/20; A23B 7/154; A23L 3/358; A23B 4/24; A23B 7/157

(52) U.S. Cl. CPC A01N 59/16; A01N 25/10; A01N 43/40; A01N 37/16; A01P 1/00; A23L 3/3544; A23V 2002/00; A23B 4/20; A23B 7/154; A23L 3/358; A23B 4/24; A23B 7/157; A23L 3/3517

(57) ABSTRACT

Described herein is an antimicrobial composition used in produce, poultry, and meat processing. The composition includes an alkylpolyglycoside having a formula: R—O-(G)n-H, where n is 1 to 2, G is a saccharide residue having 5 to 6 carbon atoms, and R is an alkyl group such that the alkylpolyglycoside has an average alkyl chain length of from 8-14. The alkylpolyglycoside is present in an active amount of from 0.01 to 8 weight percent based on a total weight of the composition. The composition also includes an antimicrobial agent chosen from organic acids, mineral acids, cetylpyridinium chloride, elemental silver and/or silver salts, and combinations thereof. The antimicrobial agent is present in an amount of from 0.002 to 2.5 weight percent based on the total weight of the composition.

### CROSS-REFERENCE TO RELATED APPLICATIONS

This application claims priority to U.S. Provisional Application No. 62/765,309, filed Aug. 20, 2018, the contents of which is incorporated herein by reference in its entirety.

### FIELD OF THE DISCLOSURE

This disclosure generally relates to an antimicrobial composition that includes an alkylpolyglycoside and an antimicrobial agent. More specifically, this disclosure relates to an antimicrobial composition that includes an alkylpolyglycoside.

### BACKGROUND

To improve food safety, the FDA and USDA, as well as meat, poultry, and produce companies, are seeking superior pathogen reduction from antimicrobial solutions. Current solutions, which are USDA or FDA registered, and/or Generally Recognized As Safe (GRAS), include antimicrobials such as chlorine, peracetic acid, cetylpyridinium chloride, silver, and mixtures of organic acids and salts. These antimicrobials exhibit performance that falls short of the desired industry performance on a consistent basis. For this reason, there remains an opportunity for improvement.

### BRIEF DESCRIPTION OF THE DISCLOSURE

This disclosure provides an antimicrobial composition for use in produce, poultry, and meat processing. The composition includes an alkylpolyglycoside having the formula: R—O-(G)ₙ, wherein n is 1 to 2, G is a saccharide residue having 5 to 6 carbon atoms, and R is an alkyl group such that the alkylpolyglycoside has an average alkyl chain length of from 8-14. The alkylpolyglycoside is present in an active amount of from 0.01 to 8 weight percent based on a total weight of the composition. The composition also includes an antimicrobial agent chosen from organic acids, mineral acids, cetylpyridinium chloride, elemental silver and/or silver salts, and combinations thereof. The antimicrobial agent is present in an amount of from 0.001 to 2.5 weight percent based on a total weight of the composition. Advantageously, compositions according to this disclosure provide greater than additive or synergistic effects for reducing microbial contamination on a foodstuff.

In one aspect, an antimicrobial composition is provided for use in produce, poultry, and meat processing. Said composition comprises an alkylpolyglycoside having a formula: R—O-(G)ₙ-H, wherein an average of n is 1 to 2, G is a saccharide residue having 5 to 6 carbon atoms, and R is an alkyl group such that said alkylpolyglycoside has an average alkyl chain length of from 8-14. Said composition further comprises an antimicrobial agent chosen from organic acids, mineral acids, cetylpyridinium chloride, elemental silver and/or silver salts, and combinations thereof. Said alkylpolyglycoside is present in an active amount of from 0.01 to 8 weight percent based on a total weight of said composition. Said antimicrobial agent is present in an amount of from 0.001 to 2.5 weight percent based on the total weight of said composition. In some embodiments, a method is provided of forming said composition, the method comprising the step of combining the alkylpolyglycoside and the antimicrobial agent. In some embodiments, a foodstuff comprising said composition is provided. In some embodiments, a method is provided of reducing microbial contamination on produce, poultry, and/or meat, the method comprising the step of applying said composition to the produce, poultry, and/or meat.

In another aspect, an antimicrobial composition is provided for use in produce, poultry, and meat processing. Said composition comprises an alkylpolyglycoside having a formula: R—O-(G)ₙ-H, wherein n is 1.5, G is a saccharide residue having 6 carbon atoms, and R is an alkyl group such that said alkylpolyglycoside has an average alkyl chain length of 10.3. Said composition further comprises an antimicrobial agent that is peracetic acid alone or in combination with H₂O₂ and 1-hydroxyethane 1,1-diphosphonic acid (HEDP), and is present in an amount of from 0.001 to 0.2 weight percent based on a total weight of said composition. Said alkylpolyglycoside is present in an active amount of from 0.01 to 2 weight percent based on the total weight of said composition.

In yet another aspect, an antimicrobial system is provided for use in produce, poultry, and meat processing to achieve an antimicrobial effect of at least a log 0.5 reduction as measured using methods set forth in the US FDA Bacteriological Analytical Manual. Said system comprises an alkylpolyglycoside having a formula: R—O-(G)ₙ-H, wherein n is 1 to 2, G is a saccharide residue having 5 to 6 carbon atoms, and R is an alkyl group such that said alkylpolyglycoside has an average alkyl chain length of from 8-14. Said system further comprises an antimicrobial agent chosen from organic acids, mineral acids, cetylpyridinium chloride, elemental silver and/or silver salts, and combinations thereof.

### DETAILED DESCRIPTION OF THE DISCLOSURE

This disclosure provides an antimicrobial composition, a method of forming the antimicrobial composition, a foodstuff that includes the antimicrobial composition, and a method of reducing microbial contamination on a foodstuff using the antimicrobial composition. The term “antimicrobial composition” may be described below as simply “composition.”

The composition is used in produce, poultry, and meat processing. Typically, the produce is further defined as “post-harvest.” The produce may be any type of produce known in the art including farm-produced crops and goods, including fruits and vegetables. Meats, poultry, grains, oats, etc. may also be considered produce in various non-limiting embodiments. Examples of produce include, but are not limited to, apricots, strawberries, cherries, peas (sugar snap and snow), cabbages including mustard greens, baby lettuce, baby spinach and watercress, artichoke, asparagus, avocado, new potatoes, rhubarb, berries (blackberries, blueberries, raspberries) and stone fruit (nectarines, peaches, and plums), melons, beets, corn, cucumber, eggplant, green beans, tomatoes and zucchini, apples, cranberries, grapes, figs, pears, and pomegranates, cultivars of wild cabbage (broccoli, brussels sprouts, cauliflower, collards, endives, and kale), root vegetables (garlic, ginger, parsnips, turnips and yams) and winter squash (acorn squash, butternut squash and pumpkins), corn, citrus (clementines, grapefruit, oranges, and lemons), rutabaga, turnips, and radishes, onions, lettuce, spinach, strawberries, etc. The meat may be any type of meat known in the art, e.g. beef, chicken, veal, lamb, etc. The terminology “meat” can include seafood of any kind known in the art in various non-limiting embodiments. The foodstuff that is to be processed or that is processed in this disclosure may be any one or more of the aforementioned produce, poultry, and/or meat.

### Alkylpolyglycoside:

The composition includes an alkylpolyglycoside having the formula: R—O-(G)ₙ-H wherein n is 1 to 2. In various embodiments, n is 1.1 to 1.9, 1.2 to 1.8, 1.3 to 1.7, 1.4 to 1.6, 1.4 to 1.7, 1.5 to 1.6, 1, 1.1, 1.2, 1.3, 1.4, 1.5, 1.6, 1.7, 1.8, or 1.9. Moreover, G is a saccharide residue having 5 to 6 carbon atoms, e.g. 5 carbon atoms or 6 carbon atoms. R is an alkyl group such that the alkylpolyglycoside has an average alkyl chain length of from 8-14 in various embodiments, the average alkyl chain length is 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, 14, or for example, from 8.0-8.9, 8.5-13.5, 12.8-13.5, 11-14, 11.7-12.9, 8.9-12.8, 9.1-12.6, 9.3-12.4, 9.5-12.2, 9.7-12, 9.9-11.8, 10.1-11.6, 10.3-11.4, 10.5-11.2, 10.7-10.7, 10.1 to 10.4, 10.2 to 10.3, 8.9-9.7, 9.3-12.8, 10-12, 9-11, 10.6-12.7, or 11-11.8. In various non-limiting embodiments, all values and range of values therebetween, which may include endpoints, are hereby expressly contemplated.

In other embodiments, the alkylpolyglycoside has the structure:

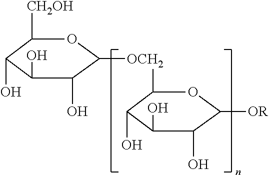

wherein n is 1 or greater and wherein R is an alkyl group having from 1 to 20 carbon atoms. In these embodiments, n may be as described above or may be from 1 to 10, 2 to 9, 3 to 8, 4 to 7, 5 to 6, 1, 2, 3, 4, 5, 6, 7, 8, 9, 10 or any value or ranges of values therebetween. Moreover, the alkyl group of these embodiments and the alkyl group relative to the aforementioned average alkyl chain length may be linear, branched, or cyclic and may have 1, 2, 3, 4, 5, 6, 7, 8, 9, 10, 11, 12, 13, 14, 15, 16, 17, 18, 19, or 20 carbon atoms. The average alkyl chain length is typically calculated as the weighted average of all alkyl chain lengths present.

Moreover the alkylpolyglycoside may be further defined as a mixture or combination of alkylpolyglycosides having differing chain lengths and structures, e.g. any chain length or structure described above. In various embodiments, the alkylpolyglycoside includes or is a mixture of compounds distribution in a Flory distribution and may include, for example, 55-60 wt % of a monoglycoside, 25 to 30 wt % of a diglycloside, 15-20 wt % of a triglycoside, 10-15 wt % of a quad-glycoside, etc. The Flory distribution is well known in the art. The average of these compounds may be described as an average degree of polymerization or average DP.

The alkylpolyglycoside is present in an active amount of from 0.01 to 8 weight percent based on a total weight of the composition. In various embodiments, the alkylpolyglycoside is present in an active amount from 0.01 to 8, 0.05 to 7.5, 0.1 to 7, 0.5 to 6.5, 1 to 6, 1.5 to 5.5, 2 to 7, 3 to 6, 4 to 5, 0.01 to 1, 0.01 to 0.1, 0.01 to 0.09, 0.02 to 0.08, 0.03 to 0.07, 0.04 to 0.06, 0.05 to 0.06, 0.1 to 0.9, 0.2 to 0.8, 0.3 to 0.7, 0.4 to 0.6, 0.5 to 0.6, 0.5 to 1, 0.5 to 5, 0.1 to 1, 0.01 to 0.1, etc., weight percent based on a total weight of the composition or 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9. 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, or 8 weight percent based on a total weight of the composition. The terminology “active” amount describes an amount of the active alkylpolyglycoside. For example, the alkylpolyglycoside may be present in a diluted form, e.g. with a solvent. The total weight of the alkylpolyglycoside and the solvent will be greater than the active amount or weight of the alkylpolyglycoside itself. In other words, the active amount or weight of the alkylpolyglycoside typically describes the amount or weight of the alkylpolyglycoside itself independent of dilution. The alkylpolyglycoside may include water and/or any other diluent or solvent known in the art. In other embodiments, the alkylpolyglycoside is further defined as a combination of 48 wt % to 52 wt % active alkylpolyglycoside in 52 wt % to 48 wt % water. Alternatively, the alkylpolyglycoside may be further defined as a combination of 1 to 50, 5 to 45, 10 to 40, 15 to 35, 20 to 30, or 25 to 30, weight percent active alkylpolyglycoside and a respective balance of water. In various non-limiting embodiments, all values and range of values therebetween, which may include endpoints, are hereby expressly contemplated.

Alkylpolyglycosides tend to be a mixture of monomers (e.g. fatty alcohol with one glucose unit) and oligomers (e.g. fatty alcohols plus various numbers of glucose units) with a distribution that follows the mathematical model developed by P. J. Flory. Typically, alkylpolyglycosides are or include a hydrophobic alkyl residue derived from a fatty alcohol and a hydrophilic saccharide structure derived from dextrose, which are linked through a glycoside bond. Some alkylpolyglycosides have alkyl residues with about 6-18 carbon atoms. In many alkylpolyglycosides, their prominent characteristic is a hydrophilic headgroup which includes a saccharide structure with one or several glycosidally interlinked D-glucose units.

An empirical formula typically does not reveal the complex stereochemistry and polyfunctionality of alkylpolyglycosides. Long chain alkyl residues may possess linear or branched carbon skeletons, although the linear moieties are usually predominant. Typically, all D-glucose units are polyhydroxyacetals, which usually differ in their ring structures as well as in the anomeric configuration of an acetal structure. Moreover, there are various options for the type of glycoside bonds between the D-glucose units of alkyl oligosaccharides. These possible variations lead to manifold, complex, chemical structures, making designation of these substances difficult.

Typically, all D-glucose units show an acetal function whose carbon atom is the only one linked to two oxygen atoms. This is called an anomeric carbon or anomeric center. The glycosidic bond with the alkyl residue, as well as the bond with the oxygen atom of the saccharide ring, originate from the anomeric carbon atom. For orientation in the carbon chain, the carbon atoms of the D-glucose units are numbered continuously (C1 to C6) starting with the anomeric carbon atom. The oxygen atoms are numbered according to their position in the chain (0-1 to 0-6). The anomeric carbon atom is asymmetrically substituted and can therefore assume two different configurations. The resulting stereoisomers are called anomers and are distinguished by the prefix α or β. According to the nomenclature conventions, α-anomers show that one of the two possible configurations whose glycosidic bond points to the right in the Fisher projection formulas of d-glucosides. The opposite is typically true of the β-anomers. This provides the structural elements for the α-D and the β-D glucosides. With one D-glucose unit, four different isomeric alkyl monoglycosides may be found, e.g. alkyl α-D-glucopyranoside; alkyl β-D-glucopyranoside; alkyl α-D-glucofuranoside; and alkyl β-D-glucofuranoside.

Alkylpolyglycosides have a disaccharide unit linked to the alkyl residue. Like monoglycosides, they also include an interglycosidic bond as a new structural element. One oxygen atom of the hydroxyl groups of the first saccharide unit is linked with the anomeric center of the second saccharide moiety. The possible choices between different types, ring forms, and anomeric configurations of the second saccharide as well as several available bonding sites at the first saccharide ring open up a multitude of structural variants. An alkyl diglycoside has a possible 64 possible isomers.

Commercially available alkylpolyglycosides may include thousands of isomeric structures of the head group. They may include from 1 to 14 glucose units per fatty alcohol. Flory, in 1951, developed a model for describing the oligomer distribution of products based on polyfunctional monomers. This distribution model has been used to describe alkylpolyglycosides as a mixture of statistically distributed oligomers. The content of individual species in the oligomer mixture decreases with increasing degree of polymerization. The oligomer distribution obtained by this mathematical model correlates well with analytical results. In simple terms, the reported degree of polymerization (DP) of alkylpolyglycoside mixtures can be calculated from the mole percent of the respective oligomeric species in the glycoside mixture, as is known in the art.

The weight percent content of individual species in this mixture decreases with increasing degree of polymerization. The majority of the species include one or two sugars per fatty alcohol. The number of sugar molecules per fatty alcohol is expressed as DP or degree of polymerization. In various embodiments, this number is from 1.3 to 1.8. This measurement has been made using HPLC techniques on multiple batches over a period of more than 15 years. The fatty alcohols used for these products tend to have carbon chains of C8, C9, C10, C11, C12, C14, and C16 or mixtures thereof. These fatty alcohols can be derived from edible food crops (e.g. corn, rapeseed, palm kernel and coconut oils.

In various embodiments, the calculated distribution of glucose units per fatty alcohol is as follows:

| # Glucose | Molecular Weight of Fatty Alcohol | | |
|---|---|---|---|
| units | 143* | 158** | 193* |
| 1 | 61.20 | 61.67 | 62.71 |
| 2 | 21.74 | 21.75 | 21.21 |
| 3 | 9.13 | 9.00 | 8.70 |
| 4 | 4.13 | 4.05 | 3.87 |
| 5 | 1.94 | 1.90 | 1.81 |
| 6 | 0.94 | 0.91 | 0.86 |
| 7 | 0.46 | 0.45 | 0.42 |
| 8 | 0.23 | 0.22 | 0.21 |
| 9 | 0.11 | 0.11 | 0.10 |
| 10 | 0.06 | 0.06 | 0.05 |
| 11 | 0.03 | 0.03 | 0.03 |
| 12 | 0.01 | 0.01 | 0.01 |
| 13 | 0.01 | 0.01 | 0.01 |
| 14 | 0.00 | 0.00 | 0.00 |

*Fatty alcohols from natural sources; i.e., primarily edible food crops identified above
**Synthetic source of fatty alcohol derived from petroleum

To synthesize alkylpolyglycosides, dextrose can be reacted directly with a fatty alcohol. Typically, glucose is dried prior to the actual reaction to minimize side reactions that will take place in the presence of water. The reaction typically uses an acid catalyst such as linear alkyl benzene sulfonic acid. The catalyst may be neutralized with sodium hydroxide. The neutralized reaction mixture typically includes 50-80% fatty alcohol. The excess fatty alcohol can be removed by vacuum distillation using a thin film evaporator leaving fatty alcohol levels of <1% in the finished product. The alkylglycoside is typically then directly dissolved in water producing a viscous 50-70% alkylpolyglycoside finished product. The product may then be refined in a bleaching step.

### Antimicrobial Agent:

The composition also includes an antimicrobial agent chosen from organic acids, mineral acids, cetylpyridinium chloride, elemental silver and/or silver salts, and combinations thereof. In one embodiment, the antimicrobial agent is an organic acid chosen from lactic acid, acetic acid, peracetic acid, octonic acid, methane sulfonic acid, propionic acid, citric acid, and combinations thereof. In another embodiment, the antimicrobial agent is a mineral acid, e.g. phosphoric acid or any other known in the art. In a further embodiment, the antimicrobial agent is cetylpyridinium chloride. In an alternative embodiment, the antimicrobial agent is elemental silver and/or silver salts, e.g. in the form of nanosilver and/or silver dihydrogen citrate. In another embodiment, the antimicrobial agent is peracetic acid alone or in combination with H₂O₂ and Etidronic acid (INN) or 1-hydroxyethane 1,1-diphosphonic acid (HEDP). In other embodiments, the antimicrobial agent, such as peracetic acid, can be combined with H₂O₂, and/or HEDP, and/or an acidifying agent. Some preferred acidifying agents include citric acid or sodium bisulfate.

The antimicrobial agent is present in an amount of from 0.001 to 2.5 weight percent based on a total weight of the composition. In various embodiments, the antimicrobial agent is present in an amount of from 1 to 2.5, 1.1 to 2.4, 1.2 to 2.3, 1.3 to 2.2, 1.4 to 2.1, 1.5 to 2, 1.6 to 1.9, 1.7 to 1.8, 0.002 to 0.010, 0.003 to 0.009, 0.004 to 0.008, 0.005 to 0.007, 0.006 to 0.007, 0.01 to 0.1, 0.02 to 0.09, 0.03 to 0.08, 0.04 to 0.07, 0.05 to 0.06, 0.1 to 1, 0.2 to 0.9, 0.3 to 0.8, 0.4 to 0.7, 0.5 to 0.6, weight percent based on a total weight of the composition, or 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9. 2, 2.1, 2.2, 2.3, 2.4, or 2.5 weight percent based on a total weight of the composition. In another embodiment, the antimicrobial agent is peracetic acid alone or in combination with H₂O₂ and HEDP and is present in an amount of from 0.001 to 0.2 weight percent based on a total weight of the composition. In further embodiments, the antimicrobial agent is an organic acid chosen from lactic acid, acetic acid, citric acid, and combinations thereof and is present in an amount of from 1 to 10 weight percent based on a total weight of the composition. In another embodiment, the antimicrobial agent includes elemental silver and/or silver salts and is present in an amount of from 0.001 to 0.01 weight percent based on a total weight of the composition. In still another embodiment, the antimicrobial agent is cetylpyridinium chloride and is present in an amount of from 0.1 to 2 weight percent based on a total weight of the composition. In various non-limiting embodiments, all values and range of values therebetween, which may include endpoints, are hereby expressly contemplated.

In various embodiments, the composition has a calculated hydrophobic lipophilic balance (HLB) of 12 to 13, e.g. 12.0, 12.1, 12.2, 12.3, 12.4, 12.5, 12.6, 12.7, 12.8, 12.9, or 13. In various non-limiting embodiments, all values and range of values therebetween, which may include endpoints, are hereby expressly contemplated. The HLB is calculated by dividing the weight average molecular weight of the hydrophilic portions of the molecule by the total weight average molecular weight of the molecule, then multiplying the result by 20. HLB=(M_{W} hydrophile/M_{W} total)*20.

In other embodiments, the composition exhibits an antimicrobial effect of at least a log 0.3, 0.4, 0.5, 1, 1.5, 2, 2.5, 3, 3.5, 4, 4.5, 5, or greater, reduction as measured using methods set forth in the US FDA Bacteriological Analytical Manual. For example, the test used may be described in the FDA Bacteriological Manual Chapter 7 for the recovery of Campylobacter. Alternatively, the test used may be described in the FDA Bacteriological Manual Chapter 4 Enumeration of Escherichia coli and the Coliform Bacteria. Alternatively, the test used may be described in the FDA Bacteriological Manual Chapter 7 for the recovery of Staphylococcus aureus and/or Listeria.

In still other embodiments, the composition has a pH of from 1 to 11, e.g. from 1.5 to 10.5, from 2 to 10, from 2.5 to 9.5, from 3 to 10, from 3 to 9, from 3.5 to 8.5, from 4 to 8, from 4.5 to 7.5, from 5 to 7, from 5.5 to 6.5, or from 5.5 to 6. In various non-limiting embodiments, all values and range of values therebetween, which may include endpoints, are hereby expressly contemplated.

### Additional Components:

Apart from the alkylpolyglycosides described above, the composition may include one or more surfactants chosen from nonionic, anionic, amphoteric and cationic surfactants, and combinations thereof. In various embodiments, a total surfactant content is from 0.01 to 50% by weight, typically 0.1 to 30% by weight, more typically 0.5 to 20% by weight, most typically 1 to 10% by weight and, in one most particularly embodiment, 2 to 5% by weight, for example 3 or 4% by weight. Levels of up to 50% by weight can be reached in concentrated or highly concentrated embodiments and typically call for corresponding dilution before use.

Suitable nonionic surfactants are, for example, other alkyl polyglycosides, C6-C22 alkyl alcohol polyglycol ethers and nitrogen-including surfactants or even sulfosuccinic acid C1-C12 alkyl esters and mixtures thereof. Other nonionic surfactants are alkoxylates, such as alkyl phenol polyglycol ethers, polyglycol ethers, end-capped polyglycol ethers, mixed ethers and hydroxy mixed ethers and also fatty acid polyglycol esters and fatty acid polyglycol ethers. Suitable polyglycol ethers (polyalkylene glycols, polyglycols) are, above all, polyethylene glycols (polymeric ethylene oxide) and polypropylene glycols (polymeric propylene oxide) and block polymers and block copolymers thereof.

Suitable nitrogen-including nonionic surfactants are, for example, amine oxides, fatty acid polyhydroxyamides, for example glucamides, and ethoxylates of alkyl amines, vicinal diols and/or carboxylic acid amides including alkyl groups with 10 to 22 carbon atoms and typically 12 to 18 carbon atoms. The degree of ethoxylation of these compounds is generally between 1 and 20 and typically between 3 and 10. Ethanolamide derivatives of alkanoic acids including 8 to 22 carbon atoms and typically 12 to 16 carbon atoms are typical. Particularly suitable compounds include lauric acid, myristic acid and palmitic acid monoethanolamides.

Amine oxides suitable for use herein include alkyl amine oxides, more particularly alkyl dimethyl amine oxides, alkylamidoamine oxides and alkoxyalkyl amine oxides. Examples of suitable amine oxides are the following compounds identified by their INCI names: Almond amidopropylamine Oxide, Babassu amidopropylamine Oxide, Behenamine Oxide, Cocamidopropyl Amine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl C8-10 Alkoxypropylamine Oxide, Dihydroxyethyl C9-11 Alkoxypropylamine Oxide, Dihydroxyethyl C12-15 Alkoxypropylamine Oxide, Dihydroxyethyl Cocamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl C12-15 Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamidopropylamine Oxide, Oleamine Oxide, Olivamidopropylamine Oxide, Palmitamidopropylamine Oxide, Palmitamine Oxide, PEG-3 Lauramine Oxide, Potassium Dihydroxyethyl Cocamine Oxide Phosphate, Potassium Trisphosphonomethylamine Oxide, Sesamidopropylamine Oxide, Soy amidopropylamine Oxide, Stearamidopropylamine Oxide, Stearamine Oxide, Tallow amidopropylamine Oxide, Tallowamine Oxide, Undecylenamido-propylamine Oxide and Wheat Germamidopropylamine Oxide. A typical amine oxide is, for example, Cocamine Oxide (N-cocoalkyl-N,N-dimethylamine oxide), Dihydroxyethyl Tallowamine Oxide (N-tallowalkyl-N,N-dihydroxyethyl amine oxide) and/or Cocamidopropylamine Oxide (cocoamidopropyl amine oxide), more particularly Cocamidopropylamine Oxide.

Other suitable surfactants are polyhydroxyfatty acid amides, whose structures are set forth in U.S. Pat. No. 6,432,892.

Suitable anionic surfactants may include at least one linear or branched, saturated or unsaturated alkyl or acyl group including 6 to 22 carbon atoms or a derivative thereof and at least one anionic head group such as, for example, aliphatic sulfates such as fatty alcohol sulfates, fatty alcohol ether sulfates, dialkyl ether sulfates and monoglyceride sulfates, aliphatic sulfonates such as alkane sulfonates, olefin sulfonates, ether sulfonates, n-alkylether sulfonates, ester sulfonates and lignin sulfonates, alkyl benzene sulfonates, fatty acid cyanamides, sulfosuccinic acid esters, fatty acid isethionates, acylaminoalkane sulfonates (fatty acid taurides), fatty acid sarcosinates, ether carboxylic acids and alkyl (ether) phosphates. Particularly suitable anionic surfactants are C8-18 alkyl sulfates, C8-18 alkyl ether sulfates, i.e. the sulfation products of the above-described alkyl alcohol polyglycol ethers, and/or C8-18 alkyl benzenesulfonates, more particularly dodecyl benzenesulfonate, but also C8-18 alkanesulfonates, C8-18.alpha.-olefin sulfonates, sulfonated C8-18 fatty acids, C8-22 carboxylic acid amide ether sulfates, sulfosuccinic acid mono-C1-12-alkyl esters, C8-18 alkyl polyglycol ether carboxylates, C8-18 N-acyl taurides, C8-18 N-sarcosinates and C8-18 alkyl isethionates and mixtures thereof.

The anionic surfactants can be used in the form of their alkali metal and alkaline earth metal salts, more particularly sodium, potassium and magnesium salts, ammonium and mono-, di-, tri- and tetra-alkyl ammonium salts and, in the case of the sulfonates, in the form of their corresponding acid, for example dodecyl benzenesulfonic acid. Where sulfonic acid is used, it is typically neutralized in situ to the above-mentioned salts with one or more corresponding bases, for example alkali metal and alkaline earth metal hydroxides, more particularly sodium, potassium and magnesium hydroxide, ammonia or mono-, di-, tri- or tetra-alkylamine.

The composition may also include one or more soaps, e.g. salts of saturated or unsaturated C6-22 carboxylic acids, and/or the corresponding acids, for their foam-suppressing properties. Typical salts are the alkali metal salts, more particularly the sodium and/or potassium salts and most typically the potassium salts. Typical C6-22 carboxylic acids are saturated and/or unsaturated, particularly monounsaturated, fatty acids including 6 to 22, typically 8 to 22, more typically 10 to 20 and most typically 12 to 18 carbon atoms, for example oleic acid, stearic acid, tallow acid, lauric acid and/or erucic acid (Z-13-docosenoic acid).

If one or more anionic surfactants, including the soaps, are used, their content in the composition is typically 0.01 to 30% by weight, typically 0.1 to 20% by weight, more typically 0.1 to 20% by weight, most typically 0.5 to 10% by weight and, in one most particularly embodiment, 1 to 5% by weight, for example 2% by weight.

In one embodiment, however, the composition includes almost no anionic surfactants and may be entirely free from soaps and even from anionic surfactants.

Suitable amphoteric surfactants (zwitterionic surfactants) are, for example, betaines, alkylamidoalkyl amines, alkyl-substituted amino acids, acylated amino acids and biosurfactants. If one or more amphoteric surfactants are used, their content in the composition, based on the composition, is typically 0.01 to 30% by weight, typically 0.1 to 20% by weight, more typically 0.5 to 10% by weight and most typically 1 to 5% by weight.

Suitable betaines are the alkyl betaines, the alkylamidobetaines, the imidazolinium betaines, the sulfobetaines (INCI Sultaines) and the phosphobetaines and typically correspond to the formulas as set forth in U.S. Pat. No. 6,432,892.

Examples of suitable betaines and sulfobetaines are the following compounds identified by their INCI names: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. Ein typical amphoteric surfactant is Cocamidopropyl Betaine (Cocoamidopropylbetaine). A particularly typical amphoteric surfactant is Capryl/Capramidopropyl Betaine (CAB) which is commercially obtainable, for example, as Tegotens B 810 from Th. Goldschmidt AG.

Typical alkylamido alkylamines (INCI Alkylamido Alkylamines) are amphoteric surfactants corresponding to formula as also set forth in U.S. Pat. No. 6,432,892.

Examples of alkylamido alkylamines are the following compounds identified by their INCI names: Cocoamphodipropionic Acid, Cocobetainamido Amphopropionate, DEA-Cocoamphodipropionate, Disodium Caproamphodiacetate, Disodium Caproamphodipropionate, Disodium Capryloamphodiacetate, Disodium Capryloamphodipropionate, Disodium Cocoamphocarboxyethylhydroxypropylsulfonate, Disodium Cocoamphodiacetate, Disodium Cocoamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-Isodeceth-7 Carboxyamphodiacetate, Disodium Stearoamphodiacetate, Disodium Tallowamphodiacetate, Disodium Wheatgermamphodiacetate, Lauroamphodipropionic Acid, Quatemium-85, Sodium Caproamphoacetate, Sodium Caproamphohydroxypropylsulfonate, Sodium Caproamphopropionate, Sodium Capryloamphoacetate, Sodium Capryloamphohydroxypropylsulfonate, Sodium Capryloamphopropionate, Sodium Cocoamphoacetate, Sodium Cocoamphohydroxypropylsulfonate, Sodium Cocoamphopropionate, Sodium Cornamphopropionate, Sodium Isostearoamphoacetate, Sodium Isostearoamphopropionate, Sodium Lauroamphoacetate, Sodium Lauroamphohydroxypropylsulfonate, Sodium Lauroampho PG-Acetate Phosphate, Sodium Lauroamphopropionate, Sodium Myristoamphoacetate, Sodium Oleoamphoacetate, Sodium Oleoamphohydroxypropylsulfonate, Sodium Oleoamphopropionate, Sodium Ricinoleoamphoacetate, Sodium Stearoamphoacetate, Sodium Stearoamphohydroxypropylsulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate and Trisodium Lauroampho PG-Acetate Chloride Phosphate.

Typical alkyl-substituted amino acids (INCI Alkyl-Substituted Amino Acids) are monoalkyl-substituted amino acids corresponding to the formulas set forth in U.S. Pat. No. 6,432,892.

Examples of alkyl-substituted amino acids are the following compounds identified by their INCI names: Aminopropyl Laurylglutamine, Cocaminobutyric Acid, Cocaminopropionic Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium C12-15 Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate and TEA-Myristamino-propionate.

The composition may also include one or more complexing agents in a quantity, based on the composition, of typically 0.01 to 20% by weight, typically 0.1 to 10% by weight, more typically 0.5 to 10% by weight, most typically 1 to 5% by weight and, in some embodiments, 1.5 to 4% by weight, for example 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, or 4% by weight.

Complexing agents (INCI Chelating Agents), also known as sequestering agents, are ingredients which are capable of complexing and inactivating metal ions to prevent them from adversely affecting the stability and appearance of the composition, for example clouding, and in particular to guarantee a clear solution, even where the composition is used with hard water. On the one hand, it is important in this regard to complex the calcium and magnesium ions of water hardness which are incompatible with many ingredients. On the other hand, complexing of the ions of heavy metals, such as iron or copper, delays the oxidative decomposition of the final composition. In addition, complexing agents support the cleaning effect.

Suitable complexing agents are, for example, alkali metal citrates, gluconates, nitrilotriacetates, carbonates and bicarbonates, more particularly sodium and potassium citrate, gluconate and nitrilotriacetate. They also include the salts of glutaric acid, succinic acid, adipic acid, tartaric acid and benzenehexacarboxylic acid and aminotrimethylene phosphonic acid, hydroxyethane-1,1-diphosphonic acid, 1-aminoethane-1,1-diphosphonic acid, ethylenediamine tetra(methylene phosphonic acid), diethylenetriamine penta(methylenephosphonic acid), 2-phosphonobutane-1,2,4-tricarboxylic acid, methylglycinediacetate (MGDA), phosphonates and phosphates, for example the sodium salts of methanediphosphonic acid, the pentasodium triphosphate known as sodium tripolyphosphate or sodium hexametaphosphate such as, for example, a mixture of condensed orthophosphates with an average degree of condensation of about 12.

Suitable complexing agents are the following compounds identified by their INCI names (some of which have already been mentioned): Aminotrimethylene Phosphonic Acid, Beta-Alanine Diacetic Acid, Calcium Disodium EDTA, Citric Acid, Cyclodextrin, Cyclohexanediamine Tetraacetic Acid, Diammonium Citrate, Diammonium EDTA, Diethylenetriamine Pentamethylene Phosphonic Acid, Dipotassium EDTA, Disodium Azacycloheptane Diphosphonate, Disodium EDTA, Disodium Pyrophosphate, EDTA, Etidronic Acid, Galactaric Acid, Gluconic Acid, Glucuronic Acid, HEDTA, Hydroxypropyl Cyclodextrin, Methyl Cyclodextrin, Pentapotassium Triphosphate, Pentasodium Aminotrimethylene Phosphonate, Pentasodium Ethylenediamine Tetramethylene Phosphonate, Pentasodium Pentetate, Pentasodium Triphosphate, Pentetic Acid, Phytic Acid, Potassium Citrate, Potassium EDTMP, Potassium Gluconate, Potassium Polyphosphate, Potassium Trisphosphonomethylamine Oxide, Ribonic Acid, Sodium Chitosan Methylene Phosphonate, Sodium Citrate, Sodium Diethylenetriamine Pentamethylene Phosphonate, Sodium Dihydroxyethylglycinate, Sodium EDTMP, Sodium Gluceptate, Sodium Gluconate, Sodium Glycereth-1 Polyphosphate, Sodium Hexametaphosphate, Sodium Metaphosphate, Sodium Metasilicate, Sodium Phytate, Sodium Polydimethylglycinophenolsulfonate, Sodium Trimetaphosphate, TEA-EDTA, TEA-Polyphosphate, Tetrahydroxyethyl Ethylenediamine, Tetrahydroxypropyl Ethylenediamine, Tetrapotassium Etidronate, Tetrapotassium Pyrophosphate, Tetrasodium EDTA, Tetrasodium Etidronate, Tetrasodium Pyrophosphate, Tripotassium EDTA, Trisodium Dicarboxymethyl Alaninate, Trisodium EDTA, Trisodium HEDTA, Trisodium NTA and Trisodium Phosphate.

Typical complexing agents are the citrates, more particularly alkali metal citrates, especially sodium citrate and/or potassium citrate and most particularly potassium citrate. The citrates are the salts of 3-times-deprotonated citric acid unless otherwise specifically stated. However, the mono- and dihydrogen citrates may also be used.

The complexing salts mentioned may also be used in the form of their corresponding acids or bases which are then partly or completely neutralized, depending on the pH value to be established, for example citric acid in the form of its monohydrate citric acid instead of citrate.

To adjust, control and/or stabilize the pH, the composition may include one or more pH regulators (INCI pH Adjusters), more particularly from the group of acids, bases and buffering agents and mixtures thereof, in a quantity, based on the composition, of typically 0.01 to 15% by weight, typically 0.1 to 10% by weight, more typically 0.5 to 5% by weight, most typically 1 to 4% by weight and, in some embodiments, 1.5 to 3% by weight, or 1.5, 1.6, 1.7, 1.8, 1.9, 2, 2.1, 2.2, 2.3, 2.4, 2.5, 2.6, 2.7, 2.8, 2.9, or 3% by weight.

Suitable pH regulators are, for example, the following compounds identified by their INCI names: Acetic Acid, Acetyl Mandelic Acid, Adipic Acid, Aluminum Triformate, 2-Aminobutanol, Aminoethyl Propanediol, Aminomethyl Propanediol, Aminomethyl Propanol, Ammonia, Ammonium Bicarbonate, Ammonium Carbamate, Ammonium Carbonate, Ammonium Glycolate, Ammonium Hydroxide, Ammonium Phosphate, Ascorbic Acid, Azelaic Acid, Benzoic Acid, Bis-Hydroxyethyl Tromethamine, Calcium Citrate, Calcium Dihydrogen Phosphate, Calcium Hydroxide, Calcium Oxide, Citric Acid, Diethanolamine, Diethanolamine Bisulfate, Diisopropanolamine, Diisopropylamine, Dimethyl MEA, Dioleoyl Edetolmonium Methosulfate, Dipotassium Phosphate, Dipropylenetriamine, Disodium Phosphate, Disodium Pyrophosphate, Disodium Tartrate, Ethanolamine, Ethanolamine HCl, Formic Acid, Fumaric Acid, Galacturonic Acid, Glucoheptonic Acid, Glucosamine HCl, Glucuronic Acid, Glycolic Acid, Glyoxylic Acid, Guanidine Carbonate, Hydrochloric Acid, Imidazole, Isopropanolamine, Isopropylamine, Ketoglutaric Acid, Lactic Acid, Lactobionic Acid, Lithium Hydroxide, Magnesium Carbonate, Magnesium Carbonate Hydroxide, Magnesium Hydroxide, Magnesium Oxide, Maleic Acid, Malic Acid, Malonic Acid, Metaphosphoric Acid, Methylethanolamine, Methylglucamine, Mixed Isopropanolamines, Monosodium Citrate, Morpholine, Oxalic Acid, Pentapotassium Triphosphate, Pentasodium Triphosphate, Phosphoric Acid, Potassium Bicarbonate, Potassium Biphthalate, Potassium Borate, Potassium Carbonate, Potassium Citrate, Potassium Hydroxide, Potassium Phosphate, Propionic Acid, Quinic Acid, Ribonic Acid, Sebacic Acid, Sodium Aluminate, Sodium Bicarbonate, Sodium Bisulfate, Sodium Borate, Sodium Carbonate, Sodium Citrate, Sodium Fumarate, Sodium Hydroxide, Sodium Oxide, Sodium Sesquicarbonate, Sodium Silicate, Sodium Succinate, Sodium Sulfate, Sodium Trimetaphosphate, Strontium Hydroxide, Succinic Acid, Sulfuric Acid, Tartaric Acid, Tetrapotassium Pyrophosphate, Tetrasodium Pyrophosphate, Triethanolamine, Triisopropanolamine, Trisodium Phosphate, Tromethamine, Vinegar.

Typical pH regulators are citric acid (as acid), hydroxides (as bases) and the citrates, carbonates and hydrogen carbonates (as buffering agents), the hydroxides and/or buffering agents typically being alkali metal salts, more particularly sodium and/or potassium salts and most particularly potassium salts.

A number of compounds act both as complexing agents and as pH regulators and, by virtue of this dual functionality, are typically used as such because they provide for particularly efficient formulation of the composition.

In some embodiments, the composition includes citric acid and alkali metal hydroxide, or corresponding citrate, together with alkali metal carbonate and/or hydrogen carbonate, more particularly citric acid and potassium hydroxide together with potassium carbonate.

In another particular embodiment of the composition, the content of carbonate ions, based on the composition, is 0.01 to less than 1% by weight, typically 0.1 to 0.9% by weight, more typically 0.3 to 0.8% by weight and most typically 0.5 to 0.7% by weight, for example 0.6% by weight.

The composition may include one or more organic solvents in a quantity, based on the composition, of 0.01 to 30% by weight, typically 0.1 to 20% by weight, more typically 1 to 15% by weight, most typically 2 to 10% by weight and, in some embodiments, 3 to 7% by weight, for example 3, 3.5, 4, 4.5, 5, 5.5, 6, 6.5, or 7% by weight.

Suitable organic solvents are, for example, saturated or unsaturated, typically saturated, branched or unbranched C1-20 hydrocarbons, typically C2-15 hydrocarbons, including one or more hydroxy groups, typically one hydroxy group, and optionally one or more ether functions C—O—C, i.e. oxygen atoms interrupting the carbon atom chain.

Typical solvents are the C1-6 alcohols, more particularly ethanol, n-propanol and/or isopropanol, typically ethanol, polyols, such as glycerol, and the C2-6 alkylene glycols and poly-C2-3-alkylene glycol ethers, optionally etherified on one side with a C1-6 alkanol, including on average 1 to 9 identical or different, typically identical, alkylene glycol groups per molecule, more particularly the poly-C2-3-alkylene glycol ethers etherified on one side with a C1-6 alkanol and including on average 1 to 9 and typically 2 to 3 ethylene or propylene glycol groups, for example PPG-2 Methyl Ether (dipropylene glycol monomethyl ether). Particularly typical organic solvents are the C1-6 alcohols ethanol, n-propanol or isopropanol, more particularly ethanol.

Other suitable organic solvents are the following compounds identified by their INCI names: Alcohol (Ethanol), Buteth-3, Butoxydiglycol, Butoxyethanol, Butoxyisopropanol, Butoxypropanol, n-Butyl Alcohol, t-Butyl Alcohol, Butylene Glycol, Butyloctanol, Diethylene Glycol, Dimethoxydiglycol, Dimethyl Ether, Dipropylene Glycol, Ethoxydiglycol, Ethoxyethanol, Ethyl Hexanediol, Glycol, Hexanediol, 1,2,6-Hexanetriol, Hexyl Alcohol, Hexylene Glycol, Isobutoxypropanol, Isopentyldiol, Isopropyl Alcohol (iso-Propanol), 3-Methoxybutanol, Methoxydiglycol, Methoxyethanol, Methoxyisopropanol, Methoxymethylbutanol, Methoxy PEG-10, Methylal, Methyl Alcohol, Methyl Hexyl Ether, Methylpropanediol, Neopentyl Glycol, PEG4, PEG-6, PEG-7, PEG-8, PEG-9, PEG-6 Methyl Ether, Pentylene Glycol, PPG-7, PPG-2-Buteth-3, PPG-2 Butyl Ether, PPG-3 Butyl Ether, PPG-2 Methyl Ether, PPG-3 Methyl Ether, PPG-2 Propyl Ether, Propanediol, Propyl Alcohol (n-Propanol), Propylene Glycol, Propylene Glycol Butyl Ether, Propylene Glycol Propyl Ether, Tetrahydrofurfuryl Alcohol, Trimethylhexanol.

Monomeric or homo- or heteropolymeric, more particularly monomeric and homo-, di- and trimeric C2-4 alkylene glycols etherified or esterified with aliphatic or aromatic alcohols, for example methanol, ethanol, n-propanol, n-butanol, tert.-butanol or phenol, or carboxylic acids, for example acetic or carbonic acid, are marketed, for example, under the name of Dowanol by Dow Chemical and under the names of Arcosolv and Arconate by Arco Chemical, such as the products listed below under their INCI names (International Dictionary of Cosmetic Ingredients published by The Cosmetic, Toiletry and Fragrance Association (CTFA)), for example butoxy diglycol (Dowanol DB), methoxydiglycol (Dowanol DM), PPG-2 Methyl Ether (Dowanol DPM), PPG-2 Methyl Ether Acetate (Dowanol DPMA), PPG-2 Butyl Ether (Dowanol DPnB), PPG-2 Propyl Ether (Dowanol DPnP), Butoxyethanol (Dowanol EB), Phenoxyethanol (Dowanol EPh), Methoxyisopropanol (Dowanol PM), PPG-1 Methyl Ether Acetate (Dowanol PMA), Butoxyisopropanol (Dowanol PnB), Propylene Glycol Propyl Ether (Dowanol PnP), Phenoxyisopropanol (Dowanol PPh), PPG-3 Methyl Ether (Dowanol TPM) and PPG-3 Butyl Ether (Dowanol TPnB) and Ethoxyisopropanol (Arcosolv PE), tert.-Butoxyisopropanol (Arcosol PTB), PPG-2 tert.-butyl ether (Arcosolv DPTB) and Propylenecarbonate (Arconate PC), of which butoxy isopropanol (dipropylene glycol-n-butyl ether, Dowanol PnB) and particularly PPG-2 Methyl Ether (dipropylene glycol methyl ether, Dowanol DPM) are typical. The composition may also include one or more perfumes, typically in the form of one or more perfume oils, in a quantity of typically 0.001 to 1% by weight, typically 0.005 to 0.5% by weight, more typically 0.01 to 0.1% by weight and most typically 0.02 to 0.05% by weight.

The composition may also include one or more auxiliaries and additives such as solubilizers, hydrotropes, emulsifiers, enzymes, preservatives, corrosion inhibitors, colorants and viscosity regulators, thickeners, and any combination thereof. Relative to all of the additional components, in various non-limiting embodiments, all values and range of values therebetween, which may include endpoints, are hereby expressly contemplated.

In various non-limiting embodiments, the composition includes one or more components as described in U.S. Pat. No. 6,432,892, which is expressly incorporated herein by reference in its entirety relative to these non-limiting embodiments.

Method of Forming:

This disclosure also provides a method of forming the composition. The method includes the step of combining the alkylpolyglycoside and the antimicrobial agent. The method may also include the step of diluting with water to any dilution desirable, e.g. less than 1, 1, 5, 10, 15, 20, 25, 30, 35, 40, 45, 50, 55, 60, 65, 70, 75, 80, 85, 90, 95, or greater, percent. The method may also include a step of pH adjustment, which can be done using any conventional method or composition for pH adjustment. In various non-limiting embodiments, all values and range of values therebetween, which may include endpoints, are hereby expressly contemplated.

Foodstuff:

This disclosure also provides the foodstuff itself. The foodstuff may be any food or consumable item. Typically, the foodstuff is meat, poultry, or produce, e.g. as described above. The foodstuff includes the food or consumable item itself and the composition disposed thereon, e.g. after application, such as spraying or pouring. The foodstuff may be alternatively described as an antimicrobially treated foodstuff.

Method of Reducing Microbial Contamination On Produce, Poultry, and/or Meat:

This disclosure also provides a method of reducing microbial contamination on a foodstuff or consumable item, e.g. produce, poultry, and/or meat. The method includes the step of applying the composition to the foodstuff or consumable item. The step of applying may be further described as pouring, spraying, wiping, dipping, brushing, etc. The composition may be rinsed off or may not be rinsed off. In other words, the step of rinsing is optional and is not required.

This disclosure also provides a process for cleaning fruit, vegetables, poultry, and/or meat in which the fruit, vegetables, poultry, and/or meat to be cleaned are first treated with the composition in undiluted or diluted form. To carry out the treatment, the composition may either be applied undiluted, typically by spraying, or the produce to be cleaned may be introduced into a cleaning bath prepared by diluting the composition with water. Typical cleaning baths include 0.1 to 10 ml, typically 0.5 to 5 ml and more typically 1 to 3.5 ml of the composition per 100 ml of bath. The composition may be removed by rinsing with running water, but this is not required. Alternate means of removal include immersion, spraying, or wiping with water or an aqueous fluid.

This disclosure also provides a method for decreasing the presence of or number of viable or living microbes or bacteria on a foodstuff including fruit, vegetables, poultry, and meat. In general, to decrease the presence of or number of viable living microbes or bacteria on a foodstuff, the process for cleaning the foodstuff is performed as described in this disclosure. Such a process reduces the presence of or number of the viable or living microbes or bacteria previously on the foodstuff by at least 10%, more preferably by at least 20%, still more preferably by at least 30, 40, 50, 60, 70, 80, 90, 95, or even 100%. Such a method also reduces the presence of or number of the viable or living microbes or bacteria when compared with conventional uses of antimicrobials on foodstuffs. This reduction can be expressed as a percentage of improvement over the conventional methods and uses of antimicrobials. For example, using the composition and methods of the present disclosure, 10, 20, 30, 40, 50, 60, 70, 80, 90, 95, or even 100% or more viable or living microbes or bacteria are inactivated or removed than when using conventional methods. Using another mode of comparison, the log reduction of microbes or bacteria is improved or higher using methods and compositions of the present disclosure than when using the methods and compositions currently available. This log reduction is in comparison to a foodstuff that has not undergone the process described herein or been contacted with the composition herein, including those that have been contacted using conventional antimicrobial compositions and techniques. The log reduction is preferably at least 0.1 to 5, including 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### EXAMPLES

### Example 1

A sample composition is formed using a particular alkylpolyglycoside and 200 ppm of peracetic acid as the antimicrobial agent. The alkylpolyglycoside is a combination of about 47 wt % of a first alkylpolyglycoside and about 43 wt % of a second alkylpolyglycoside. The first alkylpolyglycoside is formed from caprylyl compounds (D-glucose, decyl, octyl ethers, oligomeric) and decyl compounds (D-glucose, decyl, octyl ethers, oligomeric; D-Glucopyranoside, C 10-16 alkyl, oligomeric) in 62-65 active weight percent in water. The second alkylpolyglycoside is formed from lauryl compounds (D Glucopyranoside, C 10-16 alkyl, oligomeric) in 48-52 weight percent in water. The average alkyl chain length of this alkylpolyglycoside is 10.3. The methods of forming the actual first and second polyalkyglycosides are described in the detailed description above.

After formation, the composition is applied to chicken, contaminated with various bacteria, via dipping for 30 seconds of total contact time at 4° C. After application, the log reduction in bacterial count is determined. These evaluations are carried out using methods set forth in the FDA Bacteriological Manual Chapters 3, 4, 5, 7, and 10 relative to Total Plate Count, Campylobacter, Listeria, E. Coli, and Salmonella. A comparative composition that includes just peracetic acid and not alkylpolyglycoside is also evaluated. Results are set forth below.

TABLE 1

| Listeria Results | Log | | | Contact |
|---|---|---|---|---|
| PAA 200 ppm | Reduction | Application | Temperature | Time |
| 0.00% | 2.23 | Dip | 4° C. | 30 Seconds |
| Alkylpolyglycoside | | | | |
| 0.10% | 3.32 | Dip | 4° C. | 30 Seconds |
| Alkylpolyglycoside | | | | |
| 0.50% | 3.27 | Dip | 4° C. | 30 Seconds |
| Alkylpolyglycoside | | | | |
| E. Coli Results | Log | | | Contact |
| PAA 200 ppm | Reduction | Application | Temperature | Time |
| 0.00% | 2.75 | Dip | 4° C. | 30 Seconds |
| Alkylpolyglycoside | | | | |
| 0.10% | 3.52 | Dip | 4° C. | 30 Seconds |
| Alkylpolyglycoside | | | | |
| 0.50% | 4.04 | Dip | 4° C. | 30 Seconds |
| Alkylpolyglycoside | | | | |
| Salmonella Results | Log | | | Contact |
| PAA 200 ppm | Reduction | Application | Temperature | Time |
| 0.00% | 2.93 | Dip | 4° C. | 30 Seconds |
| Alkylpolyglycoside | | | | |
| 0.10% | 4.03 | Dip | 4° C. | 30 Seconds |
| Alkylpolyglycoside | | | | |
| 0.50% | 4.06 | Dip | 4° C. | 30 Seconds |
| Alkylpolyglycoside | | | | |

These results show that particular alkylpolyglycoside and 200 ppm of peracetic acid as the antimicrobial agent significantly reduce the number of foodborne illness related organisms as compared to a control.

### Example 2

The overall purpose of this example was to determine the ability of antimicrobial solutions to reduce the amount of Listeria present on the surface of produce samples.

Materials and Methods

Samples of oranges were purchased commercially by Eurofins Microbiology Laboratories. Samples were inoculated with a cocktail of Listeria monocytogenes. Post-inoculation, samples were wash-treated with various antimicrobial solutions and then evaluated. The amount of challenge organism present in the treated samples was compared to the amount present after inoculation to determine the effect of each antimicrobial concentration on the target organism. The produce items to be tested (whole oranges) were sprayed over the whole orange surface with 70% ethanol and left to dry for 10 minutes.

The antimicrobial preparations to be used were prepared as per manufacturer's instructions to a final volume of approximately 1 L as described in Example 1. The following antimicrobial solutions were prepared:
1) Peracetic acid (PAA), 80 ppm, pH 3.5
2) PAA, 80 ppm (pH adjusted to 4.0 with NaOH)
3) PAA, 80 ppm, +1.0% Alkyl Polyglycoside (“APG”) (pH adjusted to 3.5 with Citric Acid)
4) PAA, 80 ppm, +1.0% APG (pH adjusted to 4.0 with Citric Acid)

Solution 1 was measured at pH 3.5, and was not further adjusted. Solution 2 was measured adjusted to a pH of approximately 4.0 with NaOH. Solutions 3 and 4 had the pH adjusted to 3.5 and 4.0, respectively with citric acid.

### Challenge Microorganisms and Stock Solution Preparation

The following challenge microorganisms were prepared for this study:

Listeria cocktail:
Listeria monocytogenes (ATCC #19112)
Listeria monocytogenes (ATCC #19113)
Listeria monocytogenes (ATCC #13932)
Listeria monocytogenes (ATCC #19115)
Listeria monocytogenes (ATCC #7644)

Each culture was prepared from a lyophilized preparation according to manufacturer's instructions or from stock plates. Cultures were transferred into Tryptic Soy Broth (TSB, Neogen, Lansing, Mich.) and incubated at 35±2° C. for 24±2 hours. After incubation, the cultures were centrifuged (Multifuge X1R, ThermoScientific, Waltham, Mass.), washed in sterile peptone water and resuspended to their original volume before combining into a cocktail. The preparations were plated onto Tryptic Soy Agar (TSA, Neogen) at appropriate dilutions to determine the actual final concentration (targeted at 6.0-7.0 log₁₀ cfu/mL).

### Inoculation of Samples

Orange samples were directly inoculated with 1 mL of the challenge cocktail. Samples were shaken for 1 minute to distribute the inoculum evenly over the surface of the produce and stored at refrigerated temperatures (approximately 38° F./3° C.) for a minimum of 1 hour to allow for bacterial attachment.

### Treatment of Samples

Analytical samples to be treated were washed by immersion in the antimicrobial preparations described above. An initial orange sample was exposed to the treatment for 20 seconds (with gentle agitation), then drained for 2 minutes. This procedure was repeated for additional whole oranges using the same wash preparation.

### Evaluation of Samples

Orange samples were rinsed by hand using a 100 mL volume of DE Neutralizing Broth. This rinsate was considered a 10° dilution. Orange rinse samples and wash samples were plated onto PALCAM Agar (Neogen). Samples were serially diluted and plated at appropriate dilutions. PALCAM plates were incubated at 35-37° C. for 24-48 hours. After incubation, samples were enumerated by hand using a Quebec colony counter (Model #3325, Reichert Technologies, Depew, N.Y.).

### Data Analysis

The raw count observed for each sample was converted to _{log 10} cfu. The populations of the challenge organism detected after each treatment were compared to the control population (washed with sterile water) to determine the ability of each antimicrobial preparation to reduce the challenge organism.

### Results and Discussion

Results for the sample evaluations are shown in Table 2 below, including treatment solution, observed pH, average result for all replicates, the _{log 10} of the average, and the log reduction (as calculated from the untreated inoculum).

TABLE 2

| Oranges | pH | Average | Log | Reduction |
|---|---|---|---|---|
| #4 PAA w/1.0% APG (acid adj.) | 3.95 | 1,433 | 3.16 | 3.06 |
| #2 PAA (pH adjusted) | 3.97 | 10,067 | 4.00 | 2.37 |
| #1 PAA | 3.5 | 11,133 | 4.05 | 2.33 |
| #3 PAA w/1.0% APG (pH adjusted) | 3.53 | 613 | 2.79 | 3.58 |

Results from the treated samples indicate that the combination of acidification and the inclusion of APG is the most effective combination at reducing Listeria monocytogenes on the surface of orange samples. Addition of APG increased the observed reduction. Further reduction of pH to 3.5 in the 1.0% APG concentration showed an even greater reduction. This indicates that the addition of APG can produce greater inactivation of Listeria monocytogenes than the use of PAA alone, and that this reduction is enhanced by the reduction in pH, rather than that attained by lower pHs alone.

### Example 3

The overall purpose of this example was to determine the ability of antimicrobial solutions to reduce the amount of Listeria present on the surface of produce samples.

### Materials and Methods

Samples of apples (Gala/Organic) were purchased commercially by Eurofins Microbiology Laboratories. Samples were inoculated with a cocktail of Listeria monocytogenes. Post-inoculation, samples were wash-treated with various antimicrobial solutions and then evaluated. The amount of challenge organism present in the treated samples was compared to the amount present after inoculation to determine the effect of each antimicrobial concentration on the target organism. Apples were sprayed over the whole apple surface (especially the stem and calyx areas) with 70% ethanol and left to dry for 10 minutes.

The antimicrobial preparations to be used were prepared as per manufacturer's instructions to a final volume of approximately 1 L as described in Example 1. The following antimicrobial solutions were prepared:
1) Peracetic acid (PAA), 80 ppm, pH 3.5
2) PAA, 80 ppm (pH adjusted to 4.0 with NaOH)
3) PAA, 80 ppm, +1.0% APG (pH adjusted to 3.5 with Citric Acid)
4) PAA, 80 ppm, +1.0% APG (pH adjusted to 4.0 with Citric Acid)

Solution 1 was measured at pH 3.5, and was not further adjusted. Solution 2 was measured adjusted to a pH of approximately 4.0 with NaOH. Solutions 3 and 4 had the pH adjusted to 3.5 and 4.0, respectively with citric acid.

### Challenge Microorganisms and Stock Solution Preparation

The following challenge microorganisms were prepared for this study:

Listeria cocktail:
Listeria monocytogenes (ATCC #19112)
Listeria monocytogenes (ATCC #19113)
Listeria monocytogenes (ATCC #13932)
Listeria monocytogenes (ATCC #19115)
Listeria monocytogenes (ATCC #7644)

Each culture was prepared from a lyophilized preparation according to manufacturer's instructions or from stock plates. Cultures were transferred into Tryptic Soy Broth (TSB, Neogen, Lansing, Mich.) and incubated at 35±2° C. for 24±2 hours. After incubation, the cultures were centrifuged (Multifuge X1R, ThermoScientific, Waltham, Mass.), washed in sterile peptone water and resuspended to their original volume before combining into a cocktail. The preparations were plated onto Tryptic Soy Agar (TSA, Neogen) at appropriate dilutions to determine the actual final concentration (targeted at 6.0-7.0 log₁₀ cfu/mL).

### Inoculation of Samples

Apple samples were directly inoculated with 1 mL of the challenge cocktail. Samples were shaken for 1 minute to distribute the inoculum evenly over the surface of the produce and stored at refrigerated temperatures (approximately 38° F./3° C.) for a minimum of 1 hour to allow for bacterial attachment.

### Treatment of Samples

Analytical samples to be treated were washed by immersion in the antimicrobial preparations described above. An initial apple sample was exposed to the treatment for 20 seconds (with gentle agitation), then drained for 2 minutes. This procedure was repeated for additional apples using the same wash preparation.

### Evaluation of Samples

Apple samples were rinsed by hand using a 100 mL volume of DE Neutralizing Broth. This rinsate was considered a 10° dilution. Apple rinse samples and wash samples were plated onto PALCAM Agar (Neogen). Samples were serially diluted and plated at appropriate dilutions. PALCAM plates were incubated at 35-37° C. for 24-48 hours. After incubation, samples were enumerated by hand using a Quebec colony counter (Model #3325, Reichert Technologies, Depew, N.Y.).

### Data Analysis

The raw count observed for each sample was converted to _{log 10} cfu. The populations of the challenge organism detected after each treatment were compared to the control population (washed with sterile water) to determine the ability of each antimicrobial preparation to reduce the challenge organism.

### Results and Discussion

Results for the sample evaluations are shown in Table 3 below, including treatment solution, observed pH, average result for all replicates, the _{log 10} of the average, and the log reduction (as calculated from the untreated inoculum).

TABLE 3

| Apples | pH | Average | Log | Reduction |
|---|---|---|---|---|
| #4 PAA w/1.0% APG (acid adj.) | 3.95 | 1,477 | 3.17 | 3.09 |
| #2 PAA (pH adjusted) | 3.97 | 9,800 | 3.99 | 2.35 |
| #1 PAA | 3.5 | 8,867 | 3.95 | 2.39 |
| #3 PAA w/1.0% APG (pH adjusted) | 3.53 | 557 | 2.75 | 3.60 |

Results from the treated samples indicate that, just as in Example 2, the combination of acidification and the inclusion of APG is the most effective combination at reducing Listeria monocytogenes on the surface of apple samples.

1. An antimicrobial composition for use in produce, poultry, and meat processing, said composition comprising:
A. an alkylpolyglycoside having a formula: R—O-(G)ₙ-H, wherein an average of n is 1 to 2, G is a saccharide residue having 5 to 6 carbon atoms, and R is an alkyl group such that said alkylpolyglycoside has an average alkyl chain length of from 8-14; and
B. an antimicrobial agent selected from the group consisting of organic acids, mineral acids, cetylpyridinium chloride, elemental silver and/or silver salts, and combinations thereof;
wherein said alkylpolyglycoside is present in an active amount of from 0.01 to 8 weight percent based on a total weight of said composition; and
wherein said antimicrobial agent is present in an amount of from 0.001 to 2.5 weight percent based on the total weight of said composition.

2. The composition of claim 1 wherein n is 1.4 to 1.7.

3. The composition of claim 1 wherein G is a saccharide residue having 6 carbon atoms.

4. The composition of claim 1 wherein the average alkyl chain length of said alkylpolyglycoside is from 10.1 to 11.5.

5. The composition of claim 1 wherein said alkylpolyglycoside is present in an active amount of from 0.01 to 2 weight percent based on the total weight of said composition.

6. The composition of claim 1 wherein said antimicrobial agent is peracetic acid alone or in combination with H₂O₂ and 1-hydroxyethane 1,1-diphosphonic acid (HEDP), and is present in an amount of from 0.001 to 0.2 weight percent based on the total weight of said composition.

7. The composition of claim 1 wherein said antimicrobial agent is an organic acid selected from the group consisting of lactic acid, acetic acid, citric acid, and combinations thereof, and is present in an amount of from 1 to 10 weight percent based on the total weight of said composition.

8. The composition of claim 1 wherein said antimicrobial agent comprises elemental silver and/or silver salts and is present in an amount of from 0.001 to 0.01 weight percent based on the total weight of said composition.

9. The composition of claim 1 wherein said antimicrobial agent is cetylpyridinium chloride and is present in an amount of from 0.1 to 2 weight percent based on the total weight of said composition.

10. The composition of claim 1 that has a calculated hydrophobic lipophilic balance (HLB) of 12 to 13.

11. The composition of claim 1 that exhibits an antimicrobial effect of at least a log 0.3 reduction as measured using methods set forth in the US FDA Bacteriological Analytical Manual.

12. The composition of claim 1 wherein said alkylpolyglycoside is a combination of 48 wt % to 52 wt % active alkylpolyglycoside in 52 wt % to 48 wt % water.

13. The composition of claim 1 further comprising water.

14. The composition of claim 1, further comprising one or more surfactants.

15. The composition of claim 1, further comprising one or more soaps.

16. The composition of claim 1, further comprising one or more complexing agents.

17. The composition of claim 1, further comprising one or more pH regulators.

18. The composition of claim 1, further comprising one or more organic solvents.

19. The composition of claim 1, further comprising one or more auxiliaries and additives.

20. A method of forming the composition of claim 1 comprising the step of combining the alkylpolyglycoside and the antimicrobial agent.

21. A foodstuff comprising the composition of claim 1.

22. A method of reducing microbial contamination on produce, poultry, and/or meat comprising
A. applying an alkylpolyglycoside having a formula: R—O-(G)ₙ-H to said produce, poultry, and/or meat, wherein an average of n is 1 to 2, G is a saccharide residue having 5 to 6 carbon atoms, and R is an alkyl group such that said alkylpolyglycoside has an average alkyl chain length of from 8-14; and
B. applying an antimicrobial agent selected from the group consisting of organic acids, mineral acids, cetylpyridinium chloride, elemental silver and/or silver salts, and combinations thereof to said produce, poultry, and/or meat to form an antimicrobial composition on said produce, poultry, and/or meat;
wherein said alkylpolyglycoside is present in an active amount of from 0.01 to 8 weight percent based on a total weight of said composition; and
wherein said antimicrobial agent is present in an amount of from 0.001 to 2.5 weight percent based on the total weight of said composition.

23. The method of claim 22, wherein the microbial contamination is reduced by at least 10% in comparison to produce, poultry, and/or meat that has not had the antimicrobial composition applied thereto.

24. The method of claim 22, wherein the microbial contamination is reduced by at least 10% in comparison to produce, poultry, and/or meat that has had a different antimicrobial composition applied thereto.

25. An antimicrobial composition for use in produce, poultry, and meat processing, said composition comprising:
A. an alkylpolyglycoside having a formula: R—O-(G)ₙ-H, wherein n is 1.5, G is a saccharide residue having 6 carbon atoms, and R is an alkyl group such that said alkylpolyglycoside has an average alkyl chain length of 10.3; and
B. an antimicrobial agent that is peracetic acid alone or in combination with H₂O₂ and 1-hydroxyethane 1,1-diphosphonic acid (HEDP), and is present in an amount of from 0.001 to 0.2 weight percent based on a total weight of said composition; and
wherein said alkylpolyglycoside is present in an active amount of from 0.01 to 2 weight percent based on the total weight of said composition.

26. The composition of claim 25 that has a calculated hydrophobic lipophilic balance (HLB) of 12 to 13.

27. The composition of claim 25 that exhibits an antimicrobial effect of at least a log 0.3 reduction as measured using methods set forth in the US FDA Bacteriological Analytical Manual.

28. An antimicrobial system for use in produce, poultry, and meat processing to achieve an antimicrobial effect of at least a log 0.5 reduction as measured using methods set forth in the US FDA Bacteriological Analytical Manual, said system comprising:
A. an alkylpolyglycoside having a formula: R—O-(G)ₙ-H, wherein n is 1 to 2, G is a saccharide residue having 5 to 6 carbon atoms, and R is an alkyl group such that said alkylpolyglycoside has an average alkyl chain length of from 8-14; and
B. an antimicrobial agent selected from the group consisting of organic acids, mineral acids, cetylpyridinium chloride, elemental silver and/or silver salts, and combinations thereof.
